(19) United States
(12) Patent Application Publication
(10) Pub. No.: US 2015/0059991 A1
(43) Pub. Date: Mar. 5, 2015

(54) DEVICE FOR ADJUSTING FABRIC ANGLE OF DOUBLE FABRIC BLINDS

(71) Applicant: COMFORTEX WINDOW FASHIONS, Maplewood, NY (US)

(72) Inventor: Jae Suk Kwak, Gyeonggi-do (KR)

(21) Appl. No.: 14/468,856

(22) Filed: Aug. 26, 2014

(30) Foreign Application Priority Data
Aug. 27, 2013 (KR) 10-2013-0101429

(51) Int. Cl. E06B 9/32; E06B 9/262

(52) U.S. Cl. CPC E06B 9/32; E06B 9/262; E06B 2009/2435
USPC 160/113

(57) ABSTRACT

The present invention relates to double fabric blinds and, more particularly, to a device for adjusting a fabric angle of the double fabric blinds, which is capable of finely adjusting an degree of openness of a front sheet, wherein a plurality of balls are sequentially held in a holding groove, e.g., as four or eight balls, inserted into an insertion groove of a rotation component, wherein the plurality of balls are rotated in a guide groove of a stopper by approximately 90 degrees or 45 degrees, thereby improving safety and omitting the use of a conventional string.

### BACKGROUND

1. Technical Field

The present invention relates to double fabric blinds and, more particularly, to a device for adjusting a fabric angle of double fabric blinds.

2. Background Art

Referring to FIGS. 1 and 2, double fabric blinds generally use a double fabric, in which a front sheet 1 and a rear sheet 2 woven from mesh are coupled to a plurality of connection fabrics 3 extending between the front sheet 1 and the rear sheet 2, as a fabric for blinds 4 wound around a winding rod 6. Each of the connection fabrics 3 has a substantially S-shaped section and is connected in the longitudinal direction such that the front sheet 1 is spaced at a predetermined distance apart from the rear sheet 2. The front and rear sheets 1 and 2 are formed from a transparent material woven from mesh, and the plurality of connection fabrics 3 are formed from a translucent material which is more flexible than those of the front and rear sheets 1 and 2. The fabric 4 for the double fabric blinds allows light from the outside to be transmitted therein via the front and rear sheets 1 and 2 when the connection fabrics 3 are spread.

As illustrated in FIG. 2, when one of the front and rear sheets 1 and 2 moves upward, the various connection fabrics 3 are folded, and thus the front sheet 1 and the rear sheet 2 are almost in contact with each other. Simultaneously, since the plurality of connection fabrics 3 are in contact with each other, the blinds enter a translucent state in which light is transmitted through the front and rear sheets 1 and 2, but is at least partially obscured.

Turning to FIG. 3, roll blinds 9 have been manufactured by using the fabric 4 of the double fabric blinds. Roll blinds 9 can include an upper case 6, which is coupled to the winding rod 5 for winding the fabric 4 of the double fabric blinds, and a lower end bar 7 having a weight on the lower end of the double fabric. Also, a driving roller 8 is disposed on one end of the winding rod 5 so as to move the double fabric in the vertical direction, and an adjustable string 8a for rotating the driving roller 8 is provided. In this state, when the adjustable string 8a is pulled, the double fabric for blinds 4 moves downward while the driving roller 8 is rotated. The connection fabric 3 disposed between the front sheet 1 and the rear sheet 2 moves downward in the folded state, and when the fabric for blinds 4 moves down to the bottom, the folded connection fabrics 3 are spread due to the weight of the lower end bar 7.

Since conventional roll blinds have a structure in which a plurality of vanes are spread due to the weight of the lower end bar only when the double fabric moves down to the bottom, there is a limitation in that the roll blinds include no elements for allowing a user to spread the folded connection fabric at a desired position, particularly at the middle or upper positions of the double fabric, and/or adjust a spread angle of the connection fabric. Also, the conventional design includes a drop-down string (adjustable string 8a) which poses a safety hazard for children who may become entangled in the string.

To solve the abovementioned limitation, “blinds with adjustment for the angle of a double fabric” are disclosed in Korean patent gazette No. 10-943408, a previously owned patent also owned by the present applicant. Since the double blinds of the previously registered patent include a driving body, an angle adjustment component, two rollers, and two adjustable strings, the structure of the blinds in this configuration is relatively complicated. Although a degree of openness of the front sheet of the double fabric is adjustable via a friction member of the angle adjustment component, the abrasiveness (and associated coefficient of friction) of the friction member may deteriorate after being used for a long time, reducing the degree of openness to which the double fabric can be adjusted.

### BRIEF SUMMARY

One Aspect of the present invention provides adjusting of double fabric blinds and, more particularly, a device for adjusting the fabric angle of the double fabric blinds, which is capable of finely adjusting a degree of openness of such a fabric since a plurality (e.g., four or eight) of balls are sequentially held and inserted in a holding groove of a rotation component, and are rotated in a guide groove of a stopper at 90 degrees or 45 degrees, thereby reducing accidents since an adjustable string is not used. Also, the device can be easily operated since a separate lower end bar is formed on the lower ends of the front sheet and rear sheet, which can provide the same function as a handle.

To achieve the abovementioned functions, embodiments of the present invention provide a device for adjusting the fabric angle of double fabric blinds, comprising: a cover provided with an insertion hole having a hook protrusion formed therein, wherein coupling protrusions are disposed symmetrical to each other on the inner circumferential surface of the cover and protrude outward; a rotation component having coupling grooves which are coupled to the coupling protrusions of the cover, disposed symmetrical to each other on the outer circumferential surface of the rotation component, and recessed inward, and insertion grooves and a coupling hole formed in the inner circumferential surface of said rotation component, wherein a plurality of balls are inserted into the insertion grooves and a stopper is coupled to the coupling hole; a stopper having a shaft insertion hole which passes through same and has a coupling groove coupled to the hook protrusion of a spring at the lower end of said stopper, so as to be inserted into the coupling hole of the rotation component, and guide grooves, inclined grooves, and holding grooves in the outer circumferential surface of same, wherein the guide grooves and inclined grooves allow the balls to be rotated, and the holding grooves hold the balls; a fixing shaft, the front of which has the coupling protrusion coupled to a washer and the rear of which has the spring coupled to the hook protrusion projecting outward, inserted into the shaft insertion hole of the stopper; and blinds which have the plurality of balls inserted into the insertion grooves of the rotation component, to adjust the angle of the double fabric by moving in the guide groove and coupling the stopper to the rotation component. The device is characterized in that when the rotation component is rotated after four balls are inserted into the guide groove of the stopper and the rotation component is coupled to the stopper, a degree of openness of the double fabric is adjusted while the four balls are sequentially held by the holding groove as the rotation component is rotated at 90 degrees.

The present invention can provide the following technical effects.

First, a user may easily and simply adjust the degree of openness of the double fabric as desired.

Second, the opened angle of the double fabric may be finely adjusted by controlling the number of the balls inserted into the insertion grooves of the rotation component.

Third, the device of the present invention is effective in that a ball chain or an adjustable string is not used, thereby improving safety for the user.

Fourth, the device has a simple structure and reduces malfunctions from occurring during operation, thereby also reducing manufacturing costs.

### BRIEF DESCRIPTION OF THE DRAWINGS

FIGS. 1-3 are views illustrating a configuration and operation of conventional double fabric blinds.

FIG. 4 is a cross-sectional view illustrating double blinds of applicant's previously registered patent disclosed in Korean patent gazette No. 10-943408.

FIG. 5 is a perspective exploded view illustrating the configuration of a device for adjusting a fabric angle of double fabric blinds according to embodiments of the present invention.

FIG. 6 is a cross-sectional view illustrating a configuration of the device for adjusting the fabric angle of double fabric blinds according to embodiments of the present invention.

FIG. 7 is a perspective view illustrating a state in which a rotation component is coupled to a cover of the device for adjusting the fabric angle of double fabric blinds according to embodiments of the present invention.

FIG. 8 is a perspective view illustrating a state in which all elements of the device for adjusting the fabric angle of double fabric blinds according to embodiments of the present invention are coupled to each other.

FIGS. 9-15 are views illustrating a state in which the device for adjusting the fabric angle of double fabric blinds according to embodiments of the present invention is used.

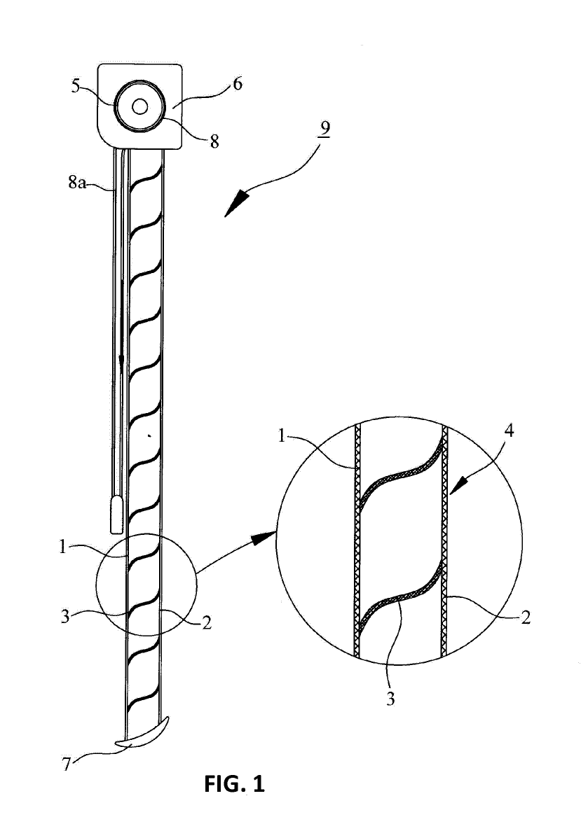

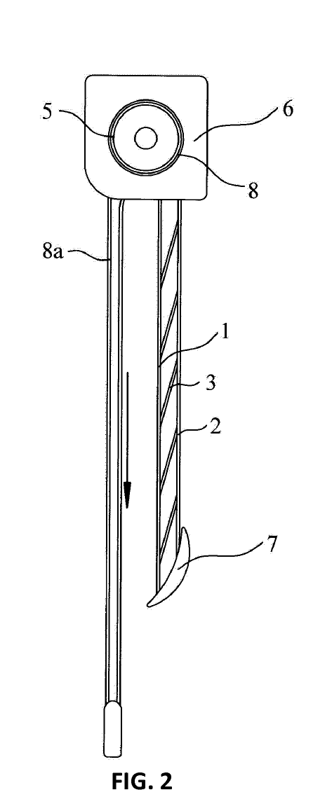

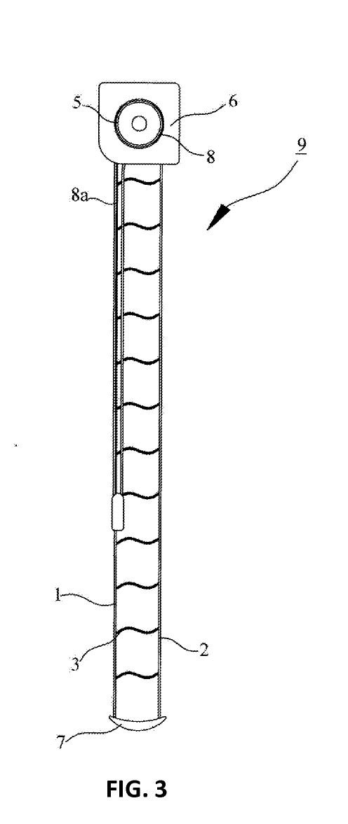

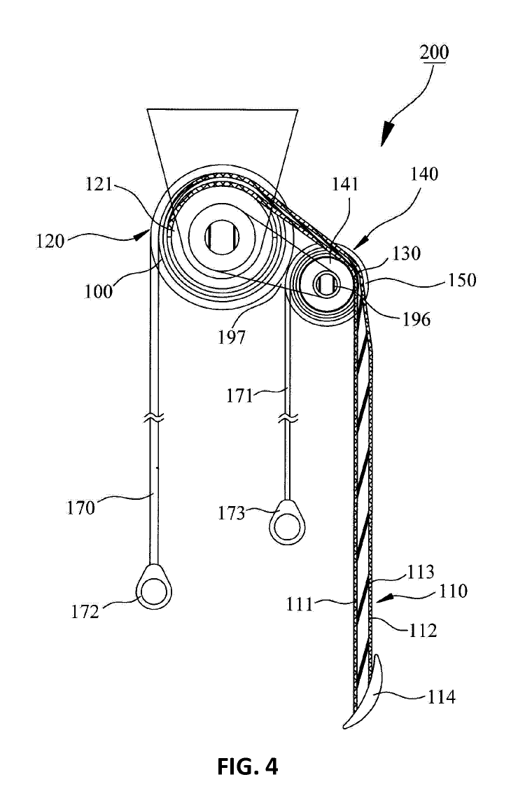

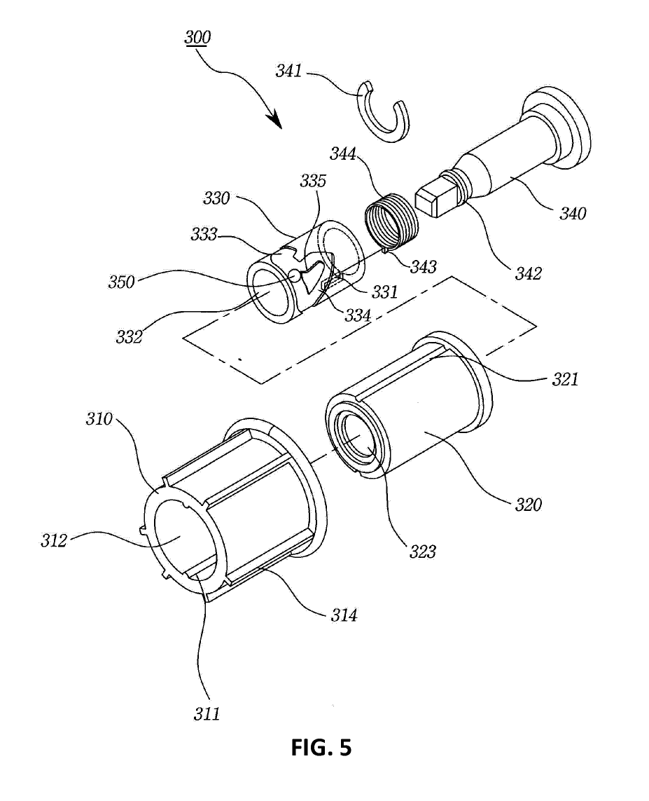

### DETAILED DESCRIPTION

Hereinafter, the preferred embodiments of the present invention will be described below in more detail with reference to the accompanying drawings.

Reference number 300 represents a body of a device for adjusting a fabric angle of double fabric blinds according to embodiments of the present invention. The body 300 includes: a cover 310 having a hook protrusion 312 on which a coupling protrusion 311 is formed; a rotation component 320 having an outer circumferential surface on which coupling grooves 321 disposed symmetrically relative to each other are formed, and an inner circumferential surface in which an insertion groove 322 and a coupling hole 323 are formed; a stopper 330 having a shaft insertion hole 332 and a coupling groove 331 formed on one surface of the outer circumferential surface of the stopper 330; the stopper having a guide groove 333, an inclined groove 334, and a holding groove 335 formed on the outer circumferential surface thereof, wherein a ball 350 is rotated in the guide grooves and inclined grooves 333 and 334 and held in the holding groove 335; and a fixing shaft 340, the front of which has a coupling protrusion 342 coupled to which a washer 341 and the rear of which is coupled to a spring 343 having a hook protrusion 343 protruding outward.

The cover 310 has an insertion hole and a hook protrusion in which coupling protrusions are formed symmetrical to each other on the inner circumferential surface of the cover, protruding outward. Also, a plurality of protrusions 314 coupled to a winding drum around which the double fabric is wound are formed on the outer circumferential surface of the cover 310. Any desired number of protrusions 314 can be provided on cover 310. The coupling grooves 321, which are symmetrical to each other and can be in the form of semicircular grooves, are formed in the outer circumferential surface of the rotation component 320. The coupling hole 323 having the insertion grooves 322, where a plurality of balls 350 are inserted, can be formed in the inner circumferential surface of the rotation component.

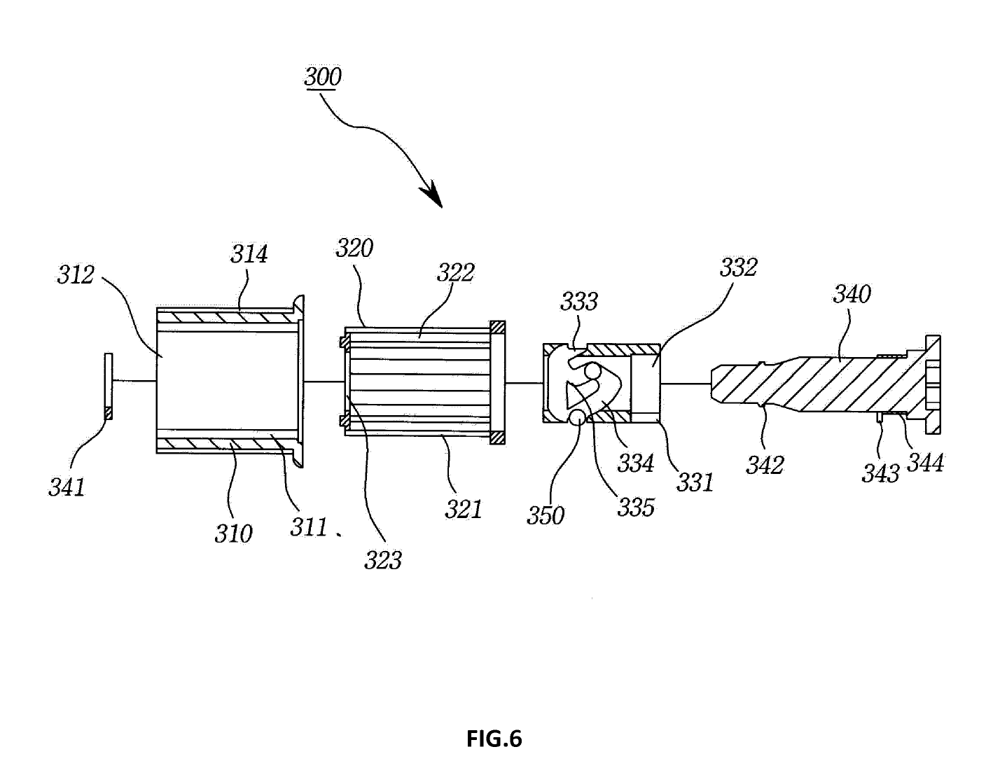

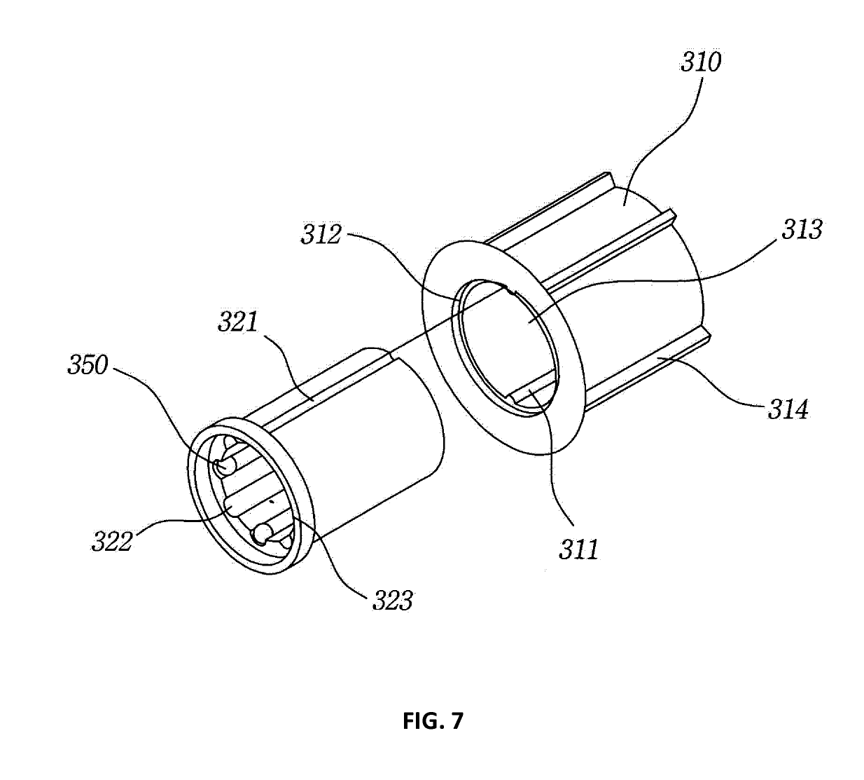

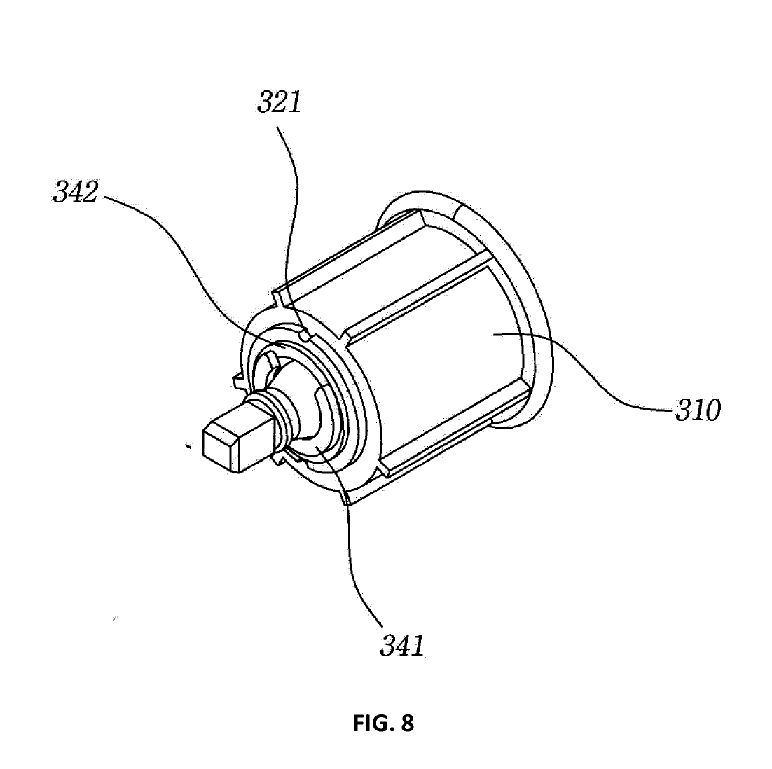

The insertion groove 323 can have a semicircular shape and extend in a longitudinal direction within the rotation component 320, which is illustrated in FIG. 6. Also, the plurality of balls 350 can be inserted into the insertion groove 323 and used as discussed herein. In particular, four balls 350 can be inserted into the insertion groove, or eight balls 350 may alternatively be inserted for use. In other embodiments, more than eight balls 350 may be used if desired. The fixing shaft 340 is inserted into the coupling hole 323 of the rotation component 320. The stopper 330 is a pipe which can have a cylindrical shape. The coupling groove 331, to which the hook protrusion 343 of the spring 344 is coupled, is formed on one area of the inner circumferential surface of the stopper and has a predetermined length. The shaft insertion hole 332 is formed in the stopper. The guide grooves and inclined grooves 333 and 334, in which each of the balls 350 is moved, and the holding groove 335 for holding the ball 350 are formed in the outer circumferential surface of the stopper 330.

One surface of the ball 350 contacts the guide groove 333 of the stopper 330, and another surface of the ball contacts the insertion groove 322 of the rotation component 320. Thus, the rotation component 320 may hold a rotation according to the movement of the ball 350. The coupling protrusion 342, to which the washer 341 is coupled, is formed on the front of the fixing shaft 340, and the spring 344 having the hook protrusion 343 protruding outward is coupled to the rear of the fixing shaft. A coupling groove 345 is formed in the central portion of the rear surface of the shaft 340 so that a coupling protrusion of a bracket is inserted. The hook protrusion 343 of the spring 344 can be disposed on the outer circumferential surface of the fixing shaft 340 and coupled to the coupling groove 331 of the stopper 330 as described above, and thus, the stopper 330 is held by the hook protrusion.

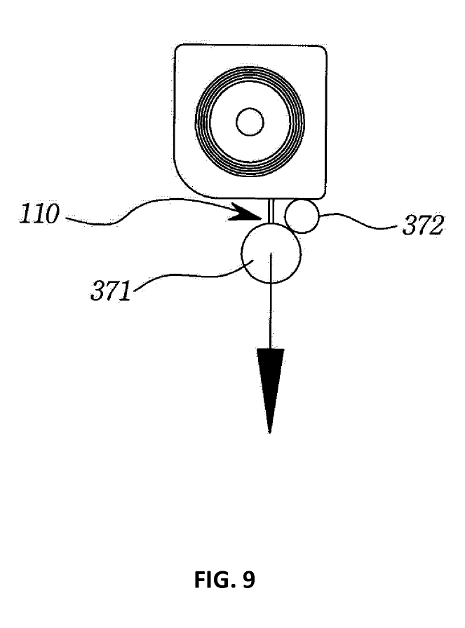

A method for operating the abovementioned device to adjust the fabric angle of the double fabric blinds according to embodiments of the present invention will be described with reference to FIGS. 9-13. First, the coupling protrusion of the bracket is coupled to the coupling groove 345 formed in the rear surface of the fixing shaft 340, and a rotor rotated due to the elastic force of a well-known spring is mounted on a spring on a surface opposite the rear surface of the fixing shaft. Further, the winding drum, around which a double fabric 110 made of a connection fabric 113 connecting a front sheet 111 and a rear sheet 112 is wound, may be coupled and fixed to the protrusion 314 of the cover 310. Lower end rods 371 and 372 are provided on the lower ends of the front and rear sheets 111 and 112, respectively. Each of the lower end rods 371 and 372 can have a cylindrical shape and the same length as the width of the fabric. A string provided with a handle may be provided at the lower side of the lower end rod 371 of the front sheet for use.

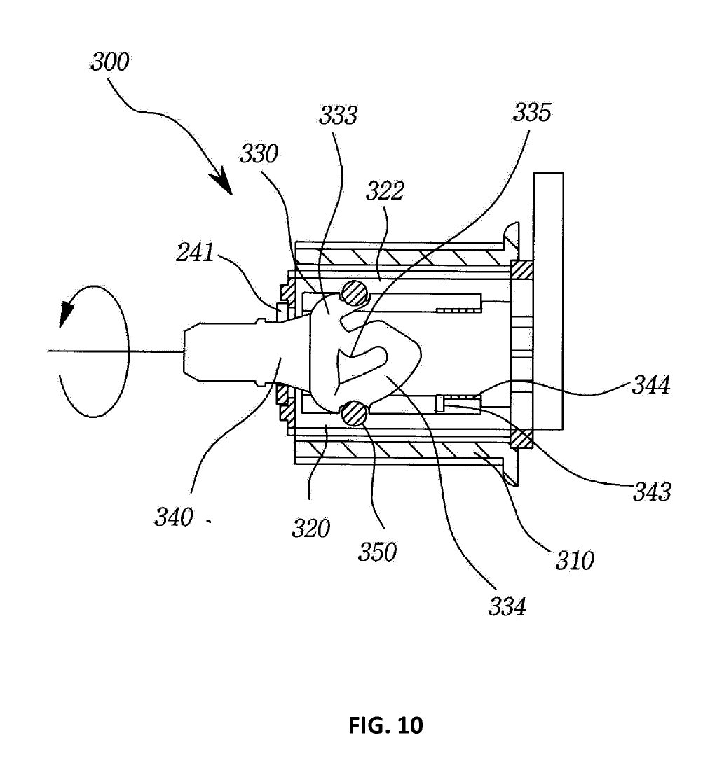

As illustrated in FIGS. 9 and 10, the lower end rod 371 of the front sheet may be gripped and pulled downward in a state in which the double fabric 110 is entirely wound around the winding drum, thereby moving the double fabric in the vertical direction. The four balls 350 located in a front side of the insertion groove 322 of the rotation component 320 are rotated in the guide groove 333 of the stopper 330. Simultaneously, the double fabric moves downward while the rotor on the opposite side is loading the spring. The fixing shaft 340 is in a fixed state, and the stopper 330 is rotated in a direction opposite to that of the spring 344 wound in a state in which the hook protrusion 343 of the spring 344 is coupled to the stopper. Simultaneously, the double fabric moves downward while the rotation component 320 is engaged with the stopper 340 and the four balls 350, and the cover 310 inserted into the coupling groove 321 of the rotation component 320 are rotated in the same direction.

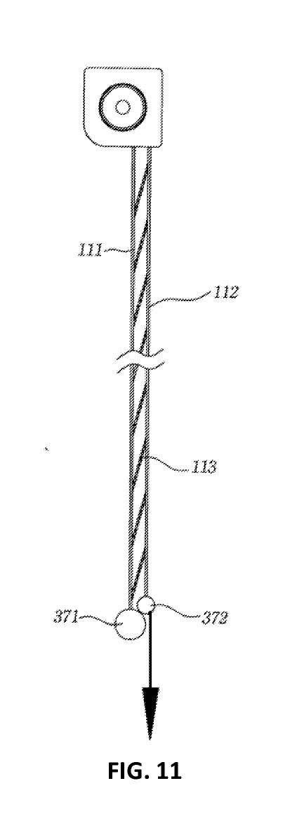

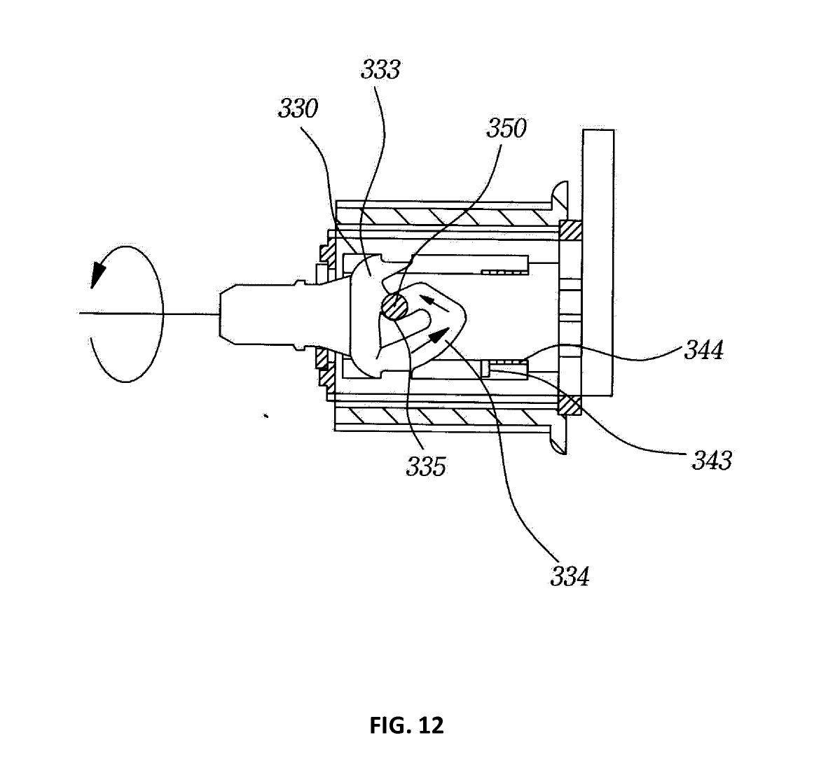

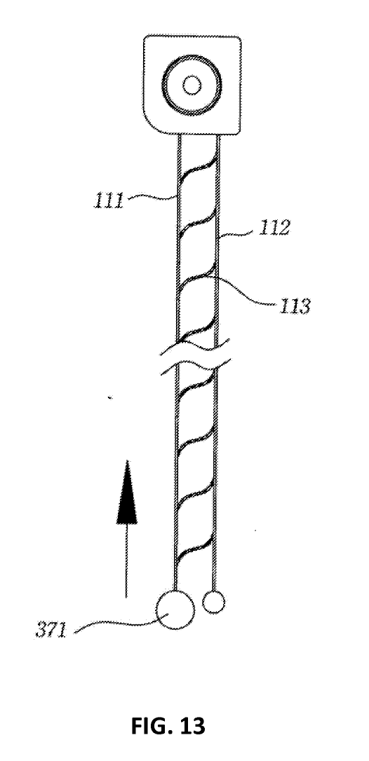

To allow sunlight to be transmitted to the inside by adjusting an degree of openness of the double fabric 110 in a state in which the double fabric 110 has moved downward to the lowest end, when the lower end rod 372 of the rear sheet is gripped and pulled downward as illustrated in FIG. 11, a first ball 350 of the four balls 350 moves along the inclined groove 334 and is located and stopped in the holding groove 335 as illustrated in FIG. 12, and simultaneously, the front sheet 111 moves upward to open the double fabric 110 as illustrated in FIG. 13. In particular, the first ball 350 of the four balls is held in the holding groove 335 when the rotation component 320 is rotated by 90 degrees to adjust the degree of openness of the double fabric, and when the lower end rod 372 of the rear sheet is pulled downward again, a second ball 350 is held in the holding groove 335 when the rotation component 320 is rotated by 90 degrees to further increase the degree of openness of the double fabric.

As described above, as the rotation component 320 is rotated by 90 degrees, the plurality of balls 350 may be sequentially held in the holding groove 355 to finely adjust the degree of openness of the double fabric. Also, according to embodiments of the present invention, eight balls 350 can be coupled to the insertion grooves 322 of the rotation component 320, and the stopper 330 is inserted into the rotation component 320, and thus the balls 350 are located in the guide groove 333 formed in the outer circumferential surface of the stopper 330. In this state, as illustrated in FIG. 11, when the lower end rod 372 of the rear sheet is gripped and pulled downward, the first ball 350 of the eight balls is held in the holding groove 335 when the rotation component 320 is rotated by 45 degrees to adjust the degree of openness of the double fabric, and when the lower end rod 372 of the rear sheet is pulled downward again, the second ball 350 is held in the holding groove 335 when the rotation component 320 is rotated by 45 degrees to further open the degree of openness of the double fabric.

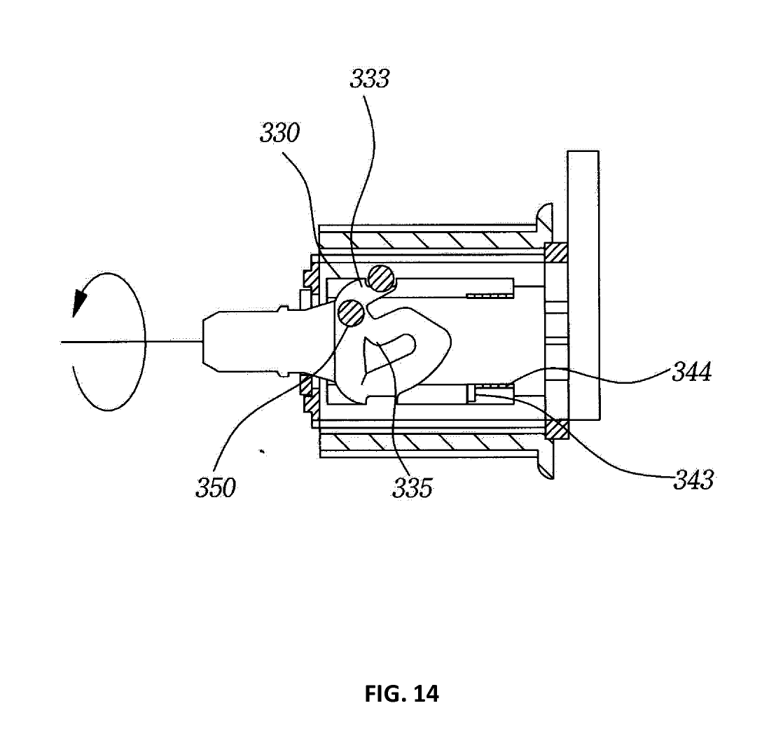

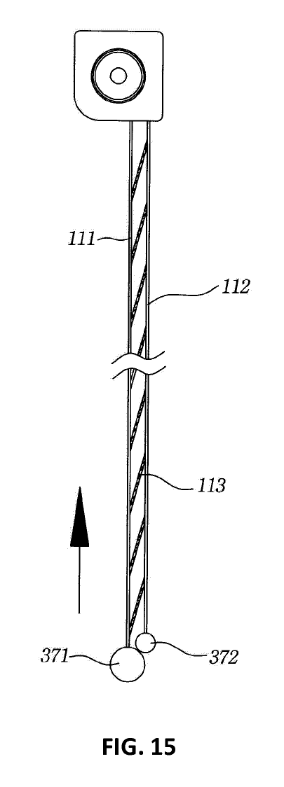

As described above, as the rotation component 320 is rotated by 45 degrees, the eight balls 350 may be sequentially held in the holding groove 355 to finely adjust the degree of openness of the double fabric. In this state, when the lower end rod 372 of the rear sheet is pulled downward such that the roller turns more than a holding angle, the ball 350 is removed from the holding groove 335 as illustrated in FIGS. 14 and 15. Simultaneously, the rotor on the opposite side is rotated as the spring loses its tension. The cover, to which the winding drum is coupled, is rotated and causes the double fabric 110 to move upward. The ball 350 may be located in the guide groove 333 of the stopper 330, which is the initial state.

What is claimed is:

1. A device for adjusting a fabric angle of double fabric blinds, the device comprising:
a cover provided with an insertion hole having a hook protrusion formed therein, wherein a plurality of coupling protrusions are disposed symmetrical to each other on an inner circumferential surface of the cover and protrude outward;
a rotation component having a plurality of coupling grooves coupled to the coupling protrusions of the cover, and disposed symmetrical to each other on an outer circumferential surface of the rotation component, and recessed inward, and including a plurality of insertion grooves and a coupling hole formed in the inner circumferential surface of the rotation component, wherein a plurality of balls are inserted into the insertion grooves and a stopper is coupled to the coupling hole;
a stopper having a shaft insertion hole therein, the stopper including a coupling groove coupled to the hook protrusion of a spring at a lower end of said stopper, so as to be inserted into the coupling hole of the rotation component, and guide grooves, inclined grooves, and holding grooves in an outer circumferential surface of the coupling hole, wherein the guide grooves and inclined grooves allow the balls to be rotated, and the holding grooves hold the balls;
a fixing shaft, a front of the fixing shaft including the coupling protrusion coupled to a washer, and a rear of the fixing shaft including the spring coupled to the hook protrusion projecting outward, inserted into the shaft insertion hole of the stopper; and
blinds which include the plurality of balls inserted into the insertion grooves of the rotation component, wherein the blinds adjust an angle of the double fabric with balls moving in the guide groove by coupling the stopper to the rotation component.

2. A device for adjusting a fabric angle of double fabric blinds, wherein the device comprises:
a cover provided with an insertion hole having a hook protrusion formed therein, wherein a plurality of coupling protrusions are disposed symmetrical to each other on an inner circumferential surface of the cover and protrude outward;
a rotation component having coupling grooves, which are coupled to the coupling protrusions of the cover, disposed symmetrical to each other on the outer circumferential surface of the rotation component, and recessed inward, and insertion grooves and a coupling hole formed in an inner circumferential surface of the rotation component, wherein a plurality of balls are inserted into the insertion grooves and a stopper is coupled to the coupling hole;
a stopper having a shaft insertion hole therein, and including a coupling groove coupled to the hook protrusion of a spring at a lower end of the stopper, so as to be inserted into the coupling hole of the rotation component, and guide grooves, inclined grooves, and holding grooves in an outer circumferential surface of the coupling hole, wherein the guide grooves and inclined grooves allow the balls to be rotated, and the holding grooves hold the balls;
a fixing shaft, a front of the fixing shaft including the coupling protrusion coupled to a washer, and a rear of the fixing shaft including the spring coupled to the hook protrusion projecting outward, inserted into the shaft insertion hole of the stopper; and
blinds which include the plurality of balls inserted into the insertion grooves of the rotation component, wherein the blinds adjust an angle of the double fabric with balls moving in the guide groove by coupling the stopper to the rotation component;
wherein the rotation component is rotated after four balls are inserted into the guide groove of the stopper and the rotation component is coupled to the stopper, and a degree of openness of the double fabric is adjusted while the four balls are sequentially held by the holding groove as the rotation component is rotated by 90 degrees.

3. The device of claim 2, wherein the rotation component is rotated after eight balls are inserted into the guide groove of the stopper, and the rotation component is coupled to the stopper, wherein the degree of openness of the double fabric is adjusted while the eight balls are sequentially held in the holding groove as the rotation component is rotated by 45 degrees.
